(19) United States
(12) Patent Application Publication
(10) Pub. No.: US 2026/0239338 A1
(43) Pub. Date: Aug. 13, 2026

(54) UPLINK TRANSMISSION OVER MULTIPLE SLOTS

(71) Applicant: NOKIA TECHNOLOGIES OY, Espoo (FI)

(72) Inventors: Nhat-Quang NHAN, Reims (FR); Marco MASO, Issy Les Moulineaux (FR); Claudio ROSA, Randers NV (DK); Guillermo POCOVI, Aalborg (DK); Youngsoo YUK, Seoul (KR); Jing Yuan SUN, Beijing (CN)

(21) Appl. No.: 19/156,189

(22) PCT Filed: Feb. 17, 2023
(86) PCT No.: PCT/CN2023/076870

§ 371 Date: Aug. 13, 2025

(51) Int. Cl. H04W 72/1268; H04L 5/00; H04W 72/0446

(52) U.S. Cl. CPC H04W 72/1268; H04L 5/0098; H04W 72/0446

(57) ABSTRACT

Exemplary embodiments of the present disclosure relate to uplink transmission over multiple slots. A terminal device receives scheduling information scheduling an uplink transmission across a first set of slots with a first slot type and a second set of slots with a second slot type. The terminal device determines based at least partially on the scheduling information, a first number of resource blocks (RBs) per slot for a first portion of the uplink transmission across the first set of slots and a second number of RBs per slot for a second portion of the uplink transmission across the second set of slots, and then transmits the uplink transmission to the network device. The transmission in the present disclosure may be operated in two types of slot with high performance in one type slot and high throughput in the other type slot.

### FIELD

Exemplary embodiments of the present disclosure generally relate to the field of telecommunication, and in particular, to devices, methods, apparatuses, and a computer-readable storage medium for transmitting an uplink transmission over multiple slots.

### BACKGROUND

3GPP has agreed to initiate a Rel-18 study item (RP-213591) on the evolution of duplexing operation in NR. That is to say, simultaneous downlink (DL) and uplink (UL) transmissions are allowed on different physical resource blocks (PRBs)/sub-bands within an unpaired wideband NR cell, and this is referred to as sub-band full duplex (SBFD). In SBFD operation, there are two slot types for both DL and UL transmissions, namely: SBFD slots, during which the non-overlapping DL sub-bands and UL subband(s) both exist, and Non-SBFD slots, during which the entire band is used for either DL or UL (i.e., legacy/full DL/UL slots).

Rel-17 coverage enhancement WI specifies a feature called transport block processing over multiple slots (TBoMS). This feature allows mapping a single transport block (TB) over multiple slots, i.e., resource allocation for a single PUSCH transmission may span across multiple slots, for example, SBFD slots and Non-SBFD slot. However, there is a need for enhancing the legacy TBoMS operation for well exploiting different types of slots.

### SUMMARY

In general, exemplary embodiments of the present disclosure provide a solution for transmitting an uplink transmission over multiple slots.

In a first aspect, there is provided a terminal device. The terminal device may comprise: at least one processor and at least one memory storing instructions that, when executed by the at least one processor, cause the apparatus at least to: receive, from a network device, scheduling information scheduling an uplink transmission across a first set of slots with a first slot type and a second set of slots with a second slot type; determine, based at least partially on the scheduling information, a first number of resource blocks (RBs) per slot for a first portion of the uplink transmission across the first set of slots and a second number of RBs per slot for a second portion of the uplink transmission across the second set of slots; and transmit, to the network device, the uplink transmission.

In a second aspect, there is provided a network device. The network device may comprise: at least one processor and at least one memory storing instructions that, when executed by the at least one processor, cause the apparatus at least to: transmit, to a terminal device, scheduling information which schedules an uplink transmission comprising a first portion to be transmitted across a first set of slots with a first slot type and a second portion to be transmitted across a second set of slots with a second slot type; and receive, from the terminal device, the uplink transmission, the first portion is allocated with a first number of resource blocks (RBs) per slot, the second portion is allocated with a second number of RBs per slot, and the first number and the second number are determined by the terminal device based at least partially on the scheduling information.

In a third aspect, there is provided a method. The method may comprise: receiving, at a terminal device from a network device, scheduling information scheduling an uplink transmission across a first set of slots with a first slot type and a second set of slots with a second slot type; determining, based at least partially on the scheduling information, a first number of resource blocks (RBs) per slot for a first portion of the uplink transmission across the first set of slots and a second number of RBs per slot for a second portion of the uplink transmission across the second set of slots; and transmitting, to the network device, the uplink transmission.

In a fourth aspect, there is provided a method. The method may comprise: transmitting, at a network device to a terminal device, scheduling information which schedules an uplink transmission comprising a first portion to be transmitted across a first set of slots with a first slot type and a second portion to be transmitted across a second set of slots with a second slot type; and receiving, from the terminal device, the uplink transmission, the first portion is allocated with a first number of resource blocks (RBs) per slot, the second portion is allocated with a second number of RBs per slot, and the first number and the second number are determined by the terminal device based at least partially on the scheduling information.

In a fifth aspect, there is provided an apparatus. The apparatus may comprise: means for receiving, at a terminal device from a network device, scheduling information scheduling an uplink transmission across a first set of slots with a first slot type and a second set of slots with a second slot type; means for determining, based at least partially on the scheduling information, a first number of resource blocks (RBs) per slot for a first portion of the uplink transmission across the first set of slots and a second number of RBs per slot for a second portion of the uplink transmission across the second set of slots; and means for transmitting, to the network device, the uplink transmission.

In a sixth aspect, there is provided an apparatus. The apparatus may comprise: means for transmitting, at a network device to a terminal device, scheduling information which schedules an uplink transmission comprising a first portion to be transmitted across a first set of slots with a first slot type and a second portion to be transmitted across a second set of slots with a second slot type; and means for receiving, from the terminal device, the uplink transmission, wherein the first portion is allocated with a first number of physical resource blocks (RBs) per slot, the second portion is allocated with a second number of RBs per slot, and the first number and the second number are determined by the terminal device based at least partially on the scheduling information.

In a seventh aspect, there is provided a non-transitory computer readable medium comprising program instructions for causing an apparatus to perform at least the method according to third or fourth aspect.

In an eighth aspect, there is provided a computer program comprising instructions, which, when executed by an apparatus, cause the apparatus at least to: receive, from a network device, scheduling information scheduling an uplink transmission across a first set of slots with a first slot type and a second set of slots with a second slot type; determine, based at least partially on the scheduling information, a first number of resource blocks (RBs) per slot for a first portion of the uplink transmission across the first set of slots and a second number of RBs per slot for a second portion of the uplink transmission across the second set of slots; and transmit, to the network device, the uplink transmission.

In a ninth aspect, there is provided a computer program comprising instructions, which, when executed by an apparatus, cause the apparatus at least to: transmit, to a terminal device, scheduling information which schedules an uplink transmission comprising a first portion to be transmitted across a first set of slots with a first slot type and a second portion to be transmitted across a second set of slots with a second slot type; and receive, from the terminal device, the uplink transmission, wherein the first portion is allocated with a first number of resource blocks (RBs) per slot, the second portion is allocated with a second number of RBs per slot, and the first number and the second number are determined by the terminal device based at least partially on the scheduling information.

In a tenth aspect, there is provided a terminal device. The terminal device may comprise: a receiving circuitry configured to receive, from a network device, scheduling information scheduling an uplink transmission across a first set of slots with a first slot type and a second set of slots with a second slot type; a determining circuitry configured to determine, based at least partially on the scheduling information, a first number of resource blocks (RBs) per slot for a first portion of the uplink transmission across the first set of slots and a second number of RBs per slot for a second portion of the uplink transmission across the second set of slots; and a transmitting circuitry configured to transmit, to the network device, the uplink transmission.

In an eleventh aspect, there is provided a network device. The network device may comprise: a transmitting circuitry configured to transmit, to a terminal device, scheduling information which schedules an uplink transmission comprising a first portion to be transmitted across a first set of slots with a first slot type and a second portion to be transmitted across a second set of slots with a second slot type; and a receiving circuitry configured to receive, from the terminal device, the uplink transmission, wherein the first portion is allocated with a first number of resource blocks (RBs) per slot, the second portion is allocated with a second number of RBs per slot, and the first number and the second number are determined by the terminal device based at least partially on the scheduling information.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some exemplary embodiments will now be described with reference to the accompanying drawings, in which:

FIG. 1A illustrates an example of a network environment in which some embodiments of the present disclosure may be implemented;

FIG. 1B illustrates an exemplary embodiment of the SBFD operation in which a TBoMS transmission or repetition will performed;

FIG. 1C illustrates some exemplary cross-link interferences on the SBFD slots in SBFD operation;

FIG. 1D illustrates power spectral density gain offered by TBoMS compared to single-slot PUSCH for the same TBS;

FIG. 2 illustrates an example signaling process for transmitting an uplink transmission over multiple slots in accordance with some embodiments of the present disclosure;

FIG. 3A illustrates an exemplary single TBoMS transmission in SBFD operation in accordance with some embodiments of the present disclosure;

FIG. 3B illustrates another exemplary single TBoMS transmission in SBFD operation in accordance with some embodiments of the present disclosure;

FIG. 4 illustrates an example signaling process for transmitting a TBoMS for PUSCH in SBFD operation in accordance with some embodiments of the present disclosure;

FIG. 5A illustrates an example of time domain resource and frequency domain resource determination in case a new type of TBoMS transmission is scheduled with repetitions in accordance with some embodiments of the present disclosure;

FIG. 5B illustrates another example of time domain resource and frequency domain resource determination in case a new type of TBoMS transmission is scheduled with repetitions in accordance with some embodiments of the present disclosure;

FIG. 6 illustrates a flowchart of an example method implemented at a terminal device in accordance with some embodiments of the present disclosure;

FIG. 7 illustrates a flowchart of an example method implemented at a network device in accordance with some embodiments of the present disclosure;

FIG. 8 illustrates a simplified block diagram of a device that is suitable for implementing some embodiments of the present disclosure; and

FIG. 9 illustrates a block diagram of an example of a computer-readable medium in accordance with some embodiments of the present disclosure.

Throughout the drawings, the same or similar reference numerals represent the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

Hereinafter description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of exemplary embodiments. As used herein, the term “and/or” includes any and all combinations of one or more of the listed terms.

The terminology used herein is for the purpose of describing particular embodiments only and is not intended to be limiting of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” (also referred to as “network node”) refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Hereinafter description, the terms “terminal device”, “communication device”, “terminal”, “user equipment” and “UE” may be used interchangeably.

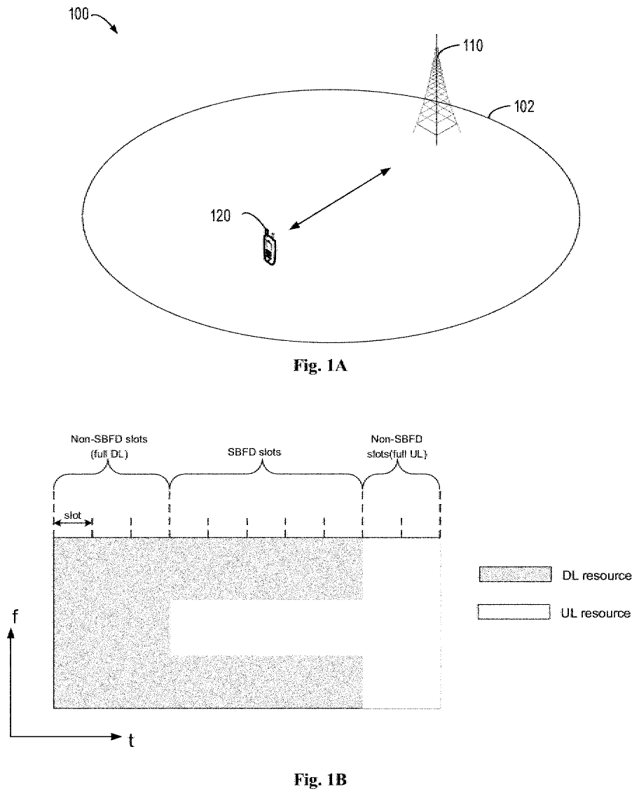

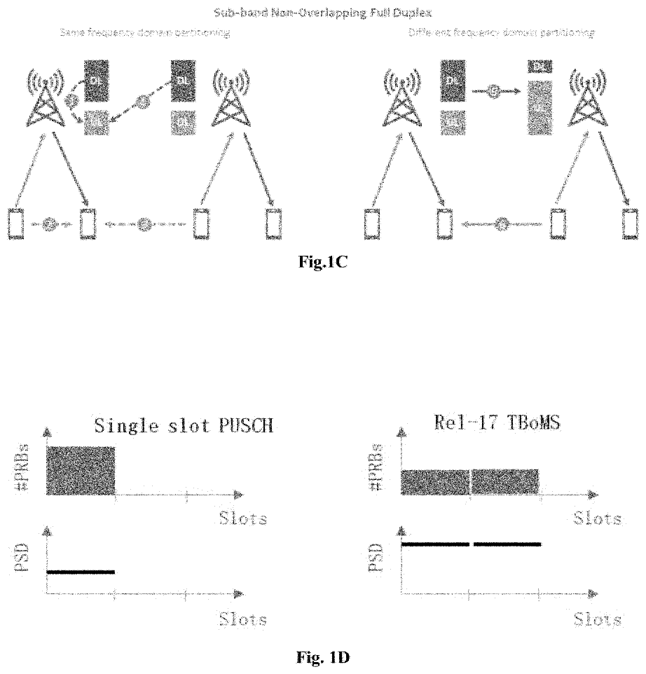

FIG. 1A illustrates an example of a network environment 100 in which some embodiments of the present disclosure may be implemented. In the descriptions of the exemplary embodiments of the present disclosure, the network environment 100 may also be referred to as a communication system 100 (for example, a portion of a communication network). For illustrative purposes only, various aspects of exemplary embodiments will be described in the context of one or more terminal devices and network devices that communicate with one another. It should be appreciated, however, that the description herein may be applicable to other types of apparatus or other similar apparatuses that are referenced using other terminology.

The network device 110 may provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some embodiments, the network device 110 may provide multiple serving cells. It is to be understood that the number of serving cell(s) shown in FIG. 1A is for illustrative purposes only without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes only without suggesting any limitation. The communication system 100 may comprise any suitable number of devices adapted for implementing embodiments of the present disclosure.

As mentioned above, Rel-17 coverage enhancement WI specifies a feature called transport block processing over multiple slots (TBoMS). This feature allows mapping a single transport block (TB) over multiple slots, i.e., resource allocation for a single PUSCH transmission may span across multiple slots. This is different from PUSCH repetitions.

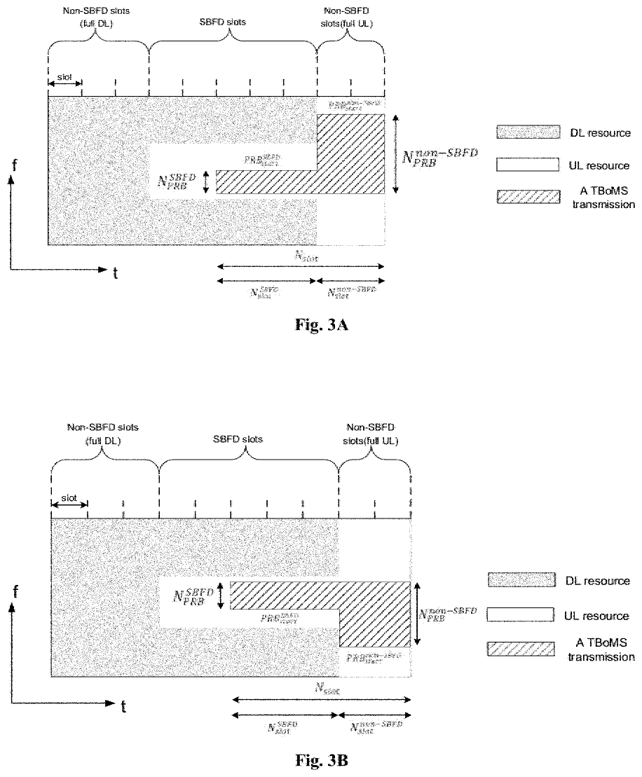

FIG. 1B illustrates an exemplary embodiment of the SBFD operation in which a TBoMS transmission or repetition will performed. In SBFD operation, there are two slot types for both DL and UL transmissions, namely: first, SBFD slots, during which the non-overlapping DL sub-bands and UL sub-bands both exist, and second, Non-SBFD slots, during which the entire band is used for either DL or UL (i.e., legacy/full DL/UL slots). In order to clearly explain the SBFD slots and the Non-SBFD slots. As illustrated in FIG. 1B, Non-SBFD slots are used for DL transmission; SBFD slots are used for both DL transmissions and UL transmissions, in some slots of the SBFD slots, at least one sub-band is used for DL transmissions and at least one sub-band is used for UL transmissions; and Non-SBFD slots are entirely used for UL transmissions. Therefore, a single TBoMS may span across multiple slots, for example, SBFD slots and Non-SBFD slots as illustrated in FIG. 3A and FIG. 3B, which will be described in detail hereinafter.

Several SBFD operation modes have been studied including whether time and frequency locations of sub-bands for SBFD operation are known to the SBFD-aware UE or not. It however has been agreed in 3GPP RAN1 #110 meeting that at least the operation mode with time and frequency locations of sub-bands for SBFD operation being known to the SBFD-aware UE is prioritized. This means that SBFD slots should be known by the (SBFD-aware) UE in one way or another way. Therefore, In SBFD operation, the bandwidth for UL sub-band in SBFD slots is limited and shared by many SBFD-aware UEs in the cell.

FIG. 1C illustrates some exemplary cross-link interferences on the SBFD slots in SBFD operation. Hereinafter, the cross-link interference (CLI) on the SBFD slots will be described with reference to FIG. 1C. As illustrated in FIG. 1C, SBFD introduces a new CLI type, namely co-channel inter-subband CLI. This interference may be better classified as:
(1). gNB self-interference;
(2). intra-cell UE-to-UE co-channel inter-subband CLI;
(3). inter-cell UE-to-UE co-channel inter-subband CLI; and
(4). gNB-to-gNB co-channel inter-subband CLI.

Besides these new CLI types 1 to 4, in case of different frequency domain partitioning in neighbor cells, the system may also suffer from co-channel intra-subband CLI, i.e. CLI from transmissions on overlapping frequency resources as follows:
(5). gNB-to-gNB inter-cell co-channel intra-subband CLI; and
(6). UE-to-UE inter-cell co-channel intra-subband CLI.

UL transmissions in SBFD slots (e.g., PUSCH in particular) would be impacted by at least the following interference: gNB self-interference (1), gNB-to-gNB co-channel inter-subband CLI (4), and gNB-to-gNB inter-cell co-channel intra-subband CLI (5) as mentioned above. This significantly impacts coverage of the UL transmissions in SBFD slots. However, UL transmissions in Non-SBFD slots would not be suffering from these interferences, at least for the case when frame structures are aligned across the cells.

As shown in FIG. 1D, one main advantage of TBoMS is that it can reduce the number of PRBs needed for transmitting the same transport block size (TBS) compared to the case when the TB is transmitted in a single slot. This helps increasing the energy per resource element (EPRE) or power spectral density as shown FIG. 1D, thereby improving the coverage. As shown in FIG. 1D, as per the design of legacy TBoMS applies the same bandwidth across the slots allocated for it. As mentioned above, a single TBoMS may span across multiple slots, for example, SBFD slots and Non-SBFD slots. In SBFD operation, the bandwidth for UL sub-band in SBFD slots is limited and shared by many SBFD-aware UEs in the cell. In addition, coexistence with other cells may lead to a scenario of intra-subband co-channel CLI, wherein some DL transmissions from other cells may happen in the UL sub-band of the current cell that uses SBFD. In this case, assuming the exchange of scheduling information among gNBs, the current gNB can avoid such interference by allocating UL transmission that does not overlap with DL transmissions from the other cells, this results in a small number of PRBs may be used for the UL transmission in the SBFD slots compared to Non-SBFD slots.

Therefore, as per the design of legacy TBoMS, if TBoMS is applied across SBFD and Non-SBFD slots, it needs to use a small number of PRBs across all allocated slots. However, this small number of PRBs is needed only for the portion of TBoMS in SBFD slot(s) for the purpose of improving the performance (for example, improving coverage), in interference slots, but not for the portion of TBoMS on Non-SBFD slot(s). In contrast, using a larger bandwidth for the portion of TBoMS in Non-SBFD slots could help to either reduce latency or increase TBS, thus improving throughput. From the above observations, an enhancement to the legacy TBoMS operation is needed for well exploiting different characteristics of SBFD and Non-SBFD slots in case a single TBoMS spans across the two slot types. The enhancement should take a tradeoff between the performance for the SBFD slots and the high throughput of Non-SBFD into consideration.

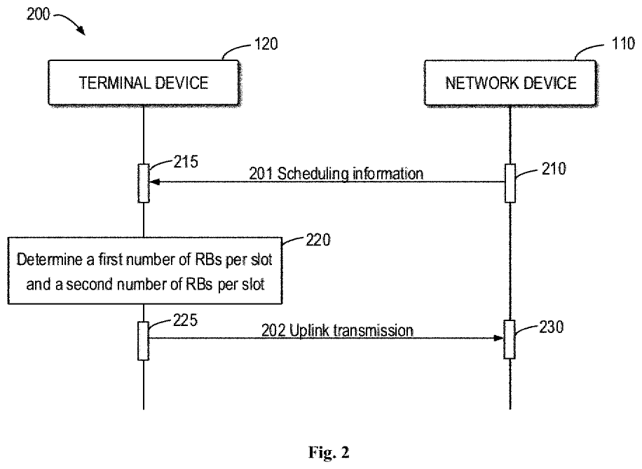

Hereinafter, an example signal process 200 for transmitting single TBoMS for PUSCH in SBFD operation will be described with reference to FIG. 2. For the purpose of discussion, the process 200 may be described with reference to FIG. 1A. The process 200 may involve the terminal device 120 and network device 110 as illustrated in FIG. 1A. It would be appreciated that although the process 200 has been described in the communication environment 100 of FIG. 1A, this process may be likewise applied to other communication scenarios with similar issues.

As shown in FIG. 2, in process 200, the network device 110 transmits (210) to the terminal device 120 scheduling information 201. The scheduling information 201 may be used to schedule an uplink transmission 202 across a first set of slots with a first slot type and a second set of slots with a second slot type. In one embodiment, the uplink transmission 202 comprises a transport block processing over multiple slots (TBoMS) without repetitions. In another embodiment, the uplink transmission 202 comprises a transport block processing over multiple slots (TBoMS) with repetitions. That is to say, the proposed process 200 is applicable for both the Uplink transmission, e.g. a TBoMS, with or without repetitions.

In process 200, the terminal device 120 receives (215) the scheduling information 201. Then, the terminal device 120 determines (220) a first number of resource blocks (RBs) per slot for a first portion of the uplink transmission 202 across the first set of slots and a second number of RBs per slot for a second portion of the uplink transmission 202 across the second set of slots. Afterwards, the terminal device 120 transmits (225) the uplink transmission 202 to the network device 110. The uplink transmission 202 includes the first portion and the second portion of the uplink transmission 202. Accordingly, the network device 110 receives (230) the uplink transmission 202 from the terminal device 120.

With the example signal process 200, by determining the RB resources for the first type slots and the RB resource for the second type slots respectively, this transmission across multiple slots may improve the performance (for example, coverage) in one type slot and simultaneously reduce latency or increase TBS, thus improving throughput in the other type slot.

In one embodiment, the first slot type is a type of sub-band full duplex (SBFD) slots or flexible slots for TDD pattern, in which at least one frequency sub-band is used for reception via downlink channels, and at least one frequency sub-band is used for transmission via uplink channels; and the second slot type is a type of Non-SBFD slots or static slots for TDD pattern, in which the entire frequency band is used for reception via downlink channels or transmission via uplink channels. In this embodiment, the first number is equal to or less than the second number.

In one example, as illustrated in FIG. 3A, in Non-SBFD slots, the entire frequency band is used for DL transmission. In SBFD slots, some frequency sub-bands are used for DL transmissions, and some other frequency sub-bands are used for UL transmission. In Non-SBFD slots, the entire frequency band is used for UL transmission. A new type of TBoMS for UL transmission may span across the SBFD slots and the Non-SBFD slots, that is to say, a single TBoMS may span across the SBFD slots and the Non-SBFD slots, for example, some of the SBFD slots and entire Non-SBFD slots. As illustrated in FIG. 3A, a single TBoMS is transmitted on the resource that spans across SBFD and Non-SBFD slots, and the first umber of PRBs allocated for the portion of resource in SBFD slots

$$( {N}_{PRB}^{SBFD} )$$

is different from (for example, less than) the second number of PRBs allocated for the portion of resource in Non-SBFD slots

$$( {N}_{PRB}^{non - SBFD} ) .$$

However, it should be noted that the first number is different, preferably less than the second number is merely a preferred embodiment, the first number may be equal to the second number as required.

In one embodiment, the scheduling information 201 comprises a total number of slots allocated for the uplink transmission, and a start slot for the uplink transmission. Prior to determining the first number of RBs and the second number of RBs, the terminal device 120 may determine the first set of slots and the second set of slots, based on the start slot for the uplink transmission and the total number of slots. For example, as shown in FIG. 3A, the total number of slots allocated for the uplink transmission, e.g. the TBoMS is Nₛₗₒₜ, for example, 5 slots. The start slot for this TBoMS is the fifth slot as shown in FIG. 3A. Then the terminal device 120 may determine the first set of slots and the second set of slots. In the example as shown in FIG. 3A, the first set of slots are 3 slots in SBFD slots, and the second set of slots are 2 slots in Non-SBFD slots.

In one embodiment, the scheduling information 201 further comprises a number of RBs per slot indicated by the network device 110. The start slot allocated for the TBoMS may be of first type, e.g. a SBFD slot, and also may be of second type, e.g. a Non-SBFD slot. In one embodiment, in the event that a start slot for the uplink transmission is of the first slot type, the first number is the number of RBs per slot indicated by the network device 110, and the second number equals to the first number scaled by a factor. In another embodiment, in the event that the start slot for the uplink transmission is of the second slot type, the second number is the number of RBs per slot indicated by the scheduling information 201, and the first number equals to the second number scaled by the factor. That is to say, the number of RBs per slot indicated by the network device 110 corresponds to the number of RBs allocated for the start slot of the TBoMS, regardless of the slot type of the start slot.

In the following, the embodiments for determining the factor α will be described.

In one embodiment, the factor is determined by the terminal device 120 or indicated by the network device 110.

In one embodiment, the factor is determined by the terminal device 120 based on a number of slots in the first set of slots and a number of slots in the second set of slots. For example, as shown in FIG. 3A,

$$α = \frac{{N}_{slot}^{SBFD}}{{N}_{slot}^{non - SBFD}} ,$$

$$or$$

$$α = \frac{{N}_{slot}^{non - SBFD}}{{N}_{slot}^{SBFD}} .$$

In one embodiment, the factor is determined by the terminal device 120 based on a number of slots in the first set of slots and a number of slots in the second set of slots, and a value configured by the network device 110. The value is configured by the network device 110 for at least one of the following: a row of a time domain resource assignment (TDRA) table, or a size of uplink frequency sub-band in slots with the first slot type.

For example, the above-mentioned different values are configured by the network device 110 for different rows of TDRA table or different sizes of the UL subband in SBFD slots or a default value of is RRC configured.

In one embodiment, the scheduling information 201 further comprises: a third number of resource blocks (RBs), which is size of the frequency sub-band for transmissions via uplink channels in slots with the first slot type; and a fourth number of RBs, which is size of the frequency band for transmissions via uplink channels in slots with the second slot type, and the factor α is determined based on the third number and the fourth number. For example, a is derived from the ratio of the total number of UL RBs in SBFD slots vs total number of UL RBs in Non-SBFD slots. For example, if the number of RBs in SBFD UL subband bandwidth is only 20% of the total RBs of the UL bandwidth in Non-SBFD slots, then α=5. For example, as shown in FIG. 3A, the factor is the ratio of the area of a part of UL resource at SBFD slots and the area of the other part of UL resource at Non-SBFD slots.

In one embodiment, the factor is configured by the network device 110 for at least one of the following: a row of a time domain resource assignment (TDRA) table, or a size of uplink frequency sub-band in slots with the first slot type. For example, a is indicated by gNB 110. For example, different values of a are configured for different rows of TDRA table, or different values of a are configured for different sizes of the UL subband in SBFD slots or a default value of a is RRC configured.

In one embodiment, the scheduling information 201 further comprises: an offset and a start RB for the uplink transmission. In one embodiment, the offset may be one of the first to fifth difference, in which: a first difference between a start RB of the first number of RBs and a start RB of the second number of RBs, a second difference is between a start RB of the frequency sub-band for transmissions via uplink channels in slots with the first slot type and the start RB of the first the second number of RBs, a third difference is between a start RB of the frequency band for transmissions via uplink channels in slots with the first slot type and the start RB of the second number of RBs; a fourth difference between a start RB of the frequency band for transmissions via uplink channels in slots with the second slot type and the start RB of the first number of RBs, or a fifth between a start RB of the frequency band for transmissions via uplink channels in slots with the second slot type and the start RB of the second number of RBs.

In one embodiment, the terminal device 120 is configured to determine a start RB for the first number of RBs, and a start RB for the second number of RBs.

In one embodiment, the terminal device 120 is configured to: determine based on the offset and the start RB for the uplink transmission, the start RB of the first number of RBs from at least one of the following: at least one of the following: the start RB of the second number of RBs; the start RB of the frequency sub-band for transmissions via uplink channels in slots with the first slot type; or the start RB of the frequency band for transmissions via uplink channels in slots with the second slot type.

In one embodiment, the terminal device 120 is configured to: determine, based on the offset and the start RB for the uplink transmission, the start RB of the second number of RBs from at least one of the following: the start RB of the first number of RBs; the start RB of the frequency sub-band for transmissions via uplink channels in slots with the first slot type; or the start RB of the frequency band for transmissions via uplink channels in slots with the second slot type.

For example, if the start RB for TBoMS transmission in SBFD slot as shown in FIG. 3A is indicated by the network device, based on the first difference, the start RB for the TBoMS transmission in Non-SBFD slot as shown in FIG. 3A may be determined.

For example, if the start RB for the UL resource in SBFD slot as shown in FIG. 3A is indicated by the network device, based on the second difference, the start RB for the TBoMS transmission in SBFD slot can be determined. If the third difference is indicated, the start RB for the TBoMS transmission in Non-SBFD slot can be determined.

For example, if the start RB for the UL resource in non-SBFD slot as shown in FIG. 3A is indicated by the network device, based on the fourth difference, the start RB for the TBoMS transmission in SBFD slot can be determined. If the fifth difference is further indicated, the start RB for the TBoMS transmission in Non-SBFD slot can be determined.

In one embodiment, in the event that a start slot for the uplink transmission is of the first slot type, the start RB of the first number of RBs is the start RB for the uplink transmission and the start RB of the second number of RBs is determined based on the first difference, or based on the second difference and the third difference, or based on the fourth difference and the fifth difference.

For example, as shown in FIG. 3A, if the start RB for TBoMs in SBFD slot is indicated by the network device, based on the first difference, the start RB for TBoMs in non-SBFD slot may be determined. If the second difference and the third difference are both indicated by the network device, the start RB for TBoMs in non-SBFD slot may be determined based on the second difference and the third difference and the start RB for TBoMs in SBFD slot.

In one embodiment, in the event that the start slot for the uplink transmission is of the second slot type, the start RB of the second number of RBs is the start RB for the uplink transmission and the start RB of the first number of RBs is determined based on the first difference, or based on the second difference and the third difference, or based on the fourth difference and the fifth difference.

For example, if the start RB for TBoMs in Non-SBFD slot is indicated by the network device, based on the first difference, the start RB for TBoMs in SBFD slot may be determined. If the fourth difference and the fifth difference are both indicated by the network device, the start RB for TBoMs in SBFD slot may be determined based on the fourth difference and the fifth difference and the start RB for TBoMs in Non-SBFD slot.

In one embodiment, the terminal device 120 is further configured to determine a transport block size (TBS) for the uplink transmission based on a product of the first number and the number of slots in the first set of slots and a product of the second number and the number of slots in the second set of slots. As shown in FIG. 3A, the transport block size (TBS) for the TBoMS is determined based on a product

$${N}_{s l o t}^{SBFD} {N}_{PRB}^{SBFD} .$$

and the other product

$${N}_{slot}^{n o n - SBFD} {N}_{P R B}^{non - SBFD} .$$

In one embodiment, the terminal device 120 is further caused to determine, the transport block size (TBS) for the uplink transmission, further based on an intermediate variable N_{info}. For example, this intermediate variable N_{info} calculated based on the product

$${N}_{slot}^{SBFD} {N}_{PRB}^{SBFD} ,$$

and the other product

$${N}_{s l o t}^{non - SBFD} {N}_{P R B}^{non - SBFD} .$$

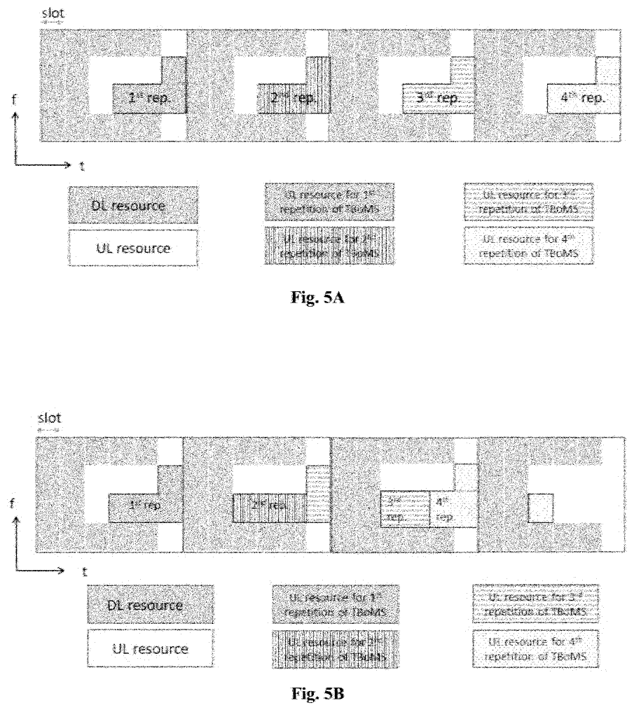

Some examples of transport block processing over multiple slots for physical uplink shared channel in SBFD operation will be described in details hereinafter with reference to FIG. 3A to 3C, and FIG. 5A and FIG. 5B.

In one embodiment, the uplink transmission comprises a transport block processing over multiple slots (TBoMS) with a plurality of repetitions, and a resource allocated for a first repetition of the plurality of repetitions is repeated at a second repetition of the plurality of repetitions in Time division duplexing (TDD) pattern. That is to say, for TBoMS in TDD pattern, the resources allocated for all repetitions are the same. In TDD patterns, a single TBoMS may span across back-to-back slots, as shown in FIGS. 3A to 3C and 5A. The example of resource allocation for TDD patterns will be described in details with reference to FIG. 5A, and will not be described here.

In one embodiment, the uplink transmission 202 comprises a transport block processing over multiple slots (TBoMS) with a plurality of repetitions, a resource in time domain for the repetition is determined by the terminal device 120 based on a total number of slots allocated for the TBoMS on available uplink slots, and the first number of RBs in frequency domain are determined for a portion of the repetition across the slots with the first slot type, and the second number of RBs in frequency domain are determined for a portion of the repetition across the slots with the second slot type. For example, in other patterns, a single TBoMS may spans across non back-to-back slots as shown in FIG. 5B. The example for this embodiment will described in details with reference to FIG. 5B hereinafter, and will not be described here.

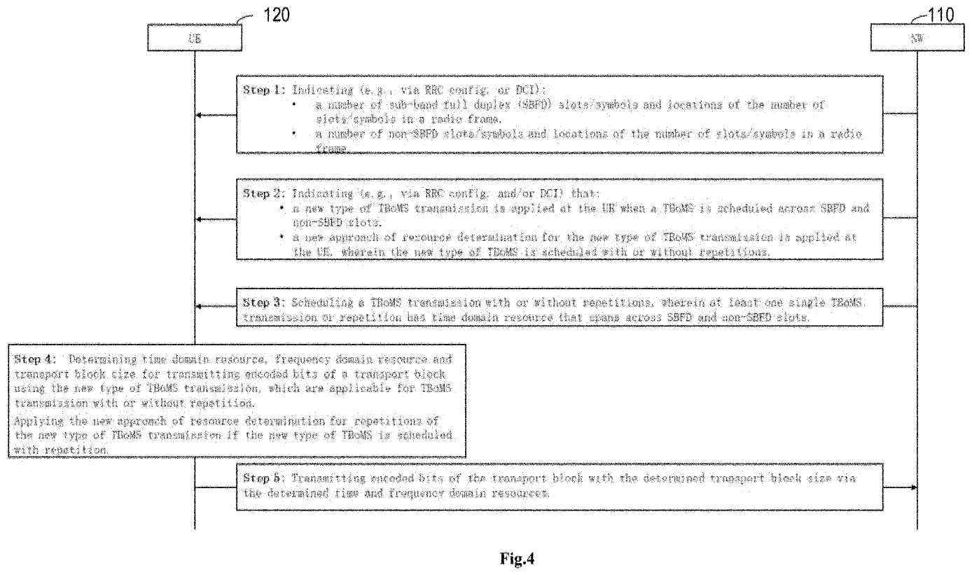

FIG. 4 illustrates an example signaling process 400 for transmitting a TBoMS for PUSCH in SBFD operation in accordance with some embodiments of the present disclosure. It is understood that the signaling process 400 can be considered as a more specific example of the signaling process 200 in FIG. 2. As shown in FIG. 4, the NW 110 is an example of the network device 110 of FIG. 1A, and the UE 120 is an example of the terminal device 120 of FIG. 1A.

At step 1, the NW 110 indicates, and the UE 120 receives the following:
(i). a frequency band;
(ii). a number of slots/symbols and locations of the number of slots/symbols in a radio frame, in these slots/symbols, the frequency band is split into multiple sub-bands and wherein at least one sub-band is used for DL transmissions and at least one sub-band is used for UL transmissions, i.e., sub-band full duplex (SBFD) slots/symbols; and
(iii). a number of slots/symbols and locations of the number of slots/symbols in a radio frame, in these slots/symbols, the entire frequency band is used for DL transmissions or UL transmissions, i.e., Non-SBFD slots/symbols.

It should be further noted that the above idea may be applied to dynamic TDD scenario, in which, the SBFD and Non-SBFD slots are replaced by flexible and static slots of dynamic TDD.

At step 2, the NW 110 indicates, and the UE 120 receives (e.g., via RRC and/or DCI) at least one indication that indicates the following:
a) a new type of TBoMS transmission is applied at the UE when a TBoMS is scheduled across SBFD and Non-SBFD slots; and
b) a new approach of resource determination for the new type of TBoMS transmission is applied at the UE, wherein the new type of TBoMS is scheduled with or without repetitions.

The at least one indication may include e.g.:
i. a scaling factor α for determination of the number of PRB to be used for TBoMS transmission in one slot type based on number of PRB allocated for the other slot type; and
ii. a PRB offset (PRB_{offset}) for determination of the start PRB to be used for TBoMS transmission in one slot type based on number of PRB allocated for the other slot type

It should be noted that the order of step 1 and step 2 are interchangeable or mergeable, they are split for the sake of clarity. It should be also noted that it is assumed that UE also reports its capability of supporting new repetition type NW as preliminary step.

At step 3, the NW 110 schedules a TBoMS transmission with or without repetitions, wherein at least one single TBoMS transmission or repetition has time domain resource that spans across SBFD slots and Non-SBFD slots.

The NW 110 indicates at least one of the following: a number of slots (Nₛₗₒₜ), a number of PRBs (N_{PRB}), and a start PRB (PRBₛₜₐᵣₜ), for the TBoMS transmission. The number of the slot Nₛₗₒₜ is the total number of slots allocated for TBoMS. In one embodiment, when the first slot allocated for TBoMS is the SBFD slot, the number of PRBs N_{PRB} is the number of physical resource blocks per SBFD slot allocated for TBoMS. In another embodiment, when the first slot allocated for TBoMS is the Non-SBFD slot, the number of PRBs N_{PRB} is the number of physical resource blocks per Non-SBFD slot allocated for TBoMS. In one embodiment, when the first slot allocated for TBoMS is the SBFD slot, the start PRB PRBₛₜₐᵣₜ for the TBoMS transmission is the start PRB for SBFD slots. In another embodiment, when the first slot allocated for TBoMS is the Non-SBFD slot, the start PRB PRBₛₜₐᵣₜ for the TBoMS transmission is the start PRB for Non-SBFD slots.

At step 4, the UE 120 determines (i) time domain resource, (ii) frequency domain resource and (iii) transport block size for transmitting encoded bits of a transport block using the new type of TBoMS transmission, which are applicable for TBoMS transmission with or without repetition. Furthermore, the UE 120 applies a new approach of resource determination for repetitions of the new type of TBoMS transmission if the new type of TBoMS is scheduled with repetition.

In one embodiment, the UE 120 determines the number of slots for the portion of TBoMS in SBFD slots

$$( {N}_{slot}^{S B F D} )$$

and the number of slots for the portion of TBoMS in Non-SBFD slots

$$( {N}_{slof}^{non - SBFD} )$$

based on the indicated total number of slots for the TBoMS transmission (Nₛₗₒₜ) and the SBFD configuration. In one embodiment, the SBFD configuration may comprise the start slot for the TBoMS transmission or repetition, the total number of SBFD slots and the total number of Non-SBFD slots used for all uplink transmissions including the TBoMS transmission or repetition. By the total number of slots for TBoMS transmission (Nₛₗₒₜ) and above-mentioned SBFD configuration, the UE 120 may determine the

$${N}_{slot}^{SBFD} and {N}_{slot}^{non - SBFD} .$$

### Examples of Frequency Domain Resource Determination

In order to determine the frequency domain resource, i.e. physical resource blocks, the UE 120 first determines a scaling factor (a) by one of the following alternatives 1, 2 and 3.

In alternative 1, in one embodiment, a is derived based on

$${N}_{slot}^{SBFD} and {N}_{slot}^{non - SBFD} ;$$

and in one embodiment,

$$α = \frac{{N}_{slot}^{SBFD}}{{N}_{slot}^{n o n - SBFD}} ( or \frac{{N}_{slot}^{n o n - SBFD}}{{N}_{slot}^{SBFD}} ) .$$

In another embodiment,

$$α = \frac{{N}_{slot}^{SBFD}}{{N}_{slot}^{n o n - SBFD}} b ,$$

where b is another scaling factor indicated by gNB (e.g., different values of b are configured for different rows of TDRA table or different values of b are configured for different sizes of the UL sub-band in SBFD slots or a default value of b is RRC configured).

In alternative 2, α is derived from the ratio of the total number of UL RBs in SBFD slots vs total number of UL RBs in Non-SBFD slots. It should be noted that

$${N}_{s l o t}^{SBFD}$$

to be determined is a part of the total number of UL RBs in SBFD slot, and

$${N}_{s l o t}^{non - SBFD}$$

to be determined in a part of total number of UL RBs in Non-SBFD slots. For example, if the number of RBs in SBFD UL sub-band bandwidth is only 20% of the total RBs of the UL bandwidth in Non-SBFD slots, then α=5.

In alternative 3, α is configured by gNB. For example, different values of a are configured for different rows of TDRA table or different values of α are configured for different sizes of the UL sub-band in SBFD slots or a default value of a is RRC configured. In this alternative, α is indicated by gNB, that is to say, a is configured by gNB 120.

Then, the UE 120 determines

$${N}_{PRB}^{n o n - SBFD} from {N}_{PRB}^{SBFD} or {N}_{PRB}^{SBFD}$$

from

$${N}_{PRB}^{non - SBFD} ,$$

based on the determined scaling factor α, N_{PRB} indicated by the NW 110 at PRB step 3, and the slot type of the first slot of the TBoMS transmission indicated by gNB 120.

In one embodiment, if the first indicated slot is a SBFD slot,

$${N}_{PRB}^{SBFD} = {N}_{PRB} ; \\ and \\ {N}_{PRB}^{n o n - SBFD} = α {N}_{PRB} .$$

In another embodiment, if the first indicated slot is a Non-SBFD slot,

$${N}_{PRB}^{SBFD} = {N}_{PRB} / α ; \\ and \\ {N}_{PRB}^{n o n - SBFD} = {N}_{PRB} .$$

Then, the UE 120 determines the

$${PRB}_{start}^{non - SBFD}$$

from

$$PR {B}_{start}^{SBFD} or {PRB}_{start}^{SBFD}$$

from

$${PRB}_{start}^{n o n - SBFD} ,$$

based on the start PRB PRBₛₜₐᵣₜ for TBOMS transmission indicated at step 3 and the PRB offset PRB_{offset} signaled in step 2, wherein PRB_{offset} may be positive or negative value.

In one example, as shown in FIG. 3A and FIG. 3B, if the first indicated slot is a SBFD slot,

$${PRB}_{s t a r t}^{SBFD} = {PRB}_{start} ; \\ and \\ {PRB}_{s t a r t}^{n o n - SBFD} = {PRB}_{s t a r t}^{SBFD} + {PRB}_{offset}$$

In another embodiment, if the first indicated slot is a Non-SBFD slot

$${PRB}_{s t a r t}^{non - SBFD} = {PRB}_{start} ; \\ and \\ {PRB}_{s t a r t}^{SBFD} = {PRB}_{s t a r t}^{non - SBFD} + {PRB}_{offset} .$$

The PRB_{offset} may be positive or negative value:

In the embodiment as illustrated in FIG. 3A in which the upper side of the TBoMS transmission in SBFD slot is lower than the upper side of the TBoMS transmission in Non-SBFD slot and the bottom sides of these two portion are aligned with each other, if the first indicated slot is a SBFD slot, the

$${PRB}_{start}^{SBFD}$$

may be the upper side of the illustrated TBoMS transmission, and the PRB_{offset} may be positive, and if the first indicated slot is a Non-SBFD slot, the

$${PRB}_{s t a r t}^{SBFD}$$

may be the upper side of the illustrated TBoMS transmission, and the PRB_{offset} may be negative.

In one embodiment, as shown in FIG. 3B in which the bottom side of the TBoMS transmission in SBFD slot is higher than the bottom side of the TBoMS transmission in Non-SBFD slot and the upper sides of these two portion are aligned with each other, if the first indicated slot is a SBFD slot, the

$${PRB}_{start}^{SBFD}$$

may be the bottom side of the illustrated TBoMS transmission, and the PRB_{offset} may be negative, and if the first indicated slot is a Non-SBFD slot, the

$${PRB}_{start}^{SBFD}$$

may be the bottom side of the illustrated TBoMS transmission, and the PRB_{offset} may be positive.

### Examples of Transport Block Size (TBS) Calculation

UE determines TBS for the TBoMS transmission by taking a summation of the determined resource on SBFD slots and the determined resource on Non-SBFD slots. In other words, TBS is calculated based on the allocated resource per SBFD slot scaled by

$${N}_{slot}^{SBFD}$$

plus the allocated resource per Non-SBFD slot scaled by

$${N}_{slot}^{non - SBFD} .$$

In one embodiment, the formula for calculating total number of REs is directly modified as

$${N}_{R E} = ( {N}_{slot}^{SBFD} {N}_{PRB}^{SBFD} + {N}_{slot}^{non - SBFD} {N}_{PRB}^{non - SBFD} ) \times min ( 156 , {N}_{RE}^{′} ) .$$

Hereinafter, the calculation for

$${N}_{RE}^{′}$$

will be described.

The UE 120 shall first determine the number of REs

$$( {N}_{RE}^{′} )$$

within the slot:
i. The UE 120 first determines the number of REs allocated for PUSCH within a PRB

$$( {N}_{RE}^{′} )$$

ii.

$${N}_{RE}^{′} = {N}_{sc}^{R B} \cdot {N}_{symb}^{sh} - {N}_{DMRS}^{PRB} - {N}_{oh}^{PRB} , where {N}_{sc}^{R B} = 12$$

is the number of subcarriers in the frequency domain in a physical resource block,

$${N}_{symb}^{sh} ,$$

i.e.

$${N}_{symb}^{slot}$$

is the number of REs for DM-RS per PRB in the allocated duration per slot including the overhead of the DM-RS, and

$${N}_{oh}^{PRB}$$

is the overhead configured by higher layer parameter xOverhead in PUSCH-ServingCellConfig. If the

$${N}_{oh}^{PRB}$$

is not configured (a value from 6, 12, or 18), the

$${N}_{oh}^{PRB}$$

is assumed to be 0.

Then, the UE 120 determines the total number of REs allocated for PUSCH (N_{RE}) as follows
i. For TB processing over multiple slots (TBoMS),

$${N}_{RE} = N * min ( 156 , {N}_{RE}^{′} ) \cdot {n}_{P R B}$$

where n_{PRB} is the total number of allocated PRBs for the UE and N is the number of slots used for TBS determination indicated by numberOfSlotsTBoMS.
ii. Otherwise,

$${N}_{R E} = min ( 156 , {N}_{RE}^{′} ) \cdot {n}_{P R B} .$$

In another embodiment, the unquantized intermediate variable (N_{info}) is calculated as

$${N}_{info} = ( {N}_{R E}^{SBFD} + {N}_{R E}^{non - SBFD} ) R {Q}_{m} ν ,$$

where

$${N}_{R E}^{S B F D}$$

is the total number of resource elements (REs) for the portion of TBoMS transmission on SBFD slots and is calculated by

$${N}_{R E}^{S B F D} = {N}_{slot}^{S B F D} \times min ( 156 , {N}_{RE}^{′} ) {N}_{P R B}^{S B F D} ; and {N}_{R E}^{non - SBFD}$$

is the total number of REs for the portion of TBoMS transmission on Non-SBFD slots and is calculated by

$${N}_{R E}^{non - SBFD} = {N}_{s l o t}^{non - SBFD} \times min ( 156 , {N}_{RE}^{′} ) {N}_{P R B}^{non - SBFD} .$$

Hereinafter, the calculation of N_{info} will be described.

The unquantized intermediate variable (N_{info}) TBSₜₑₘₚ) is obtained by N_{info}=N_{RE}·R·Qₘ·ν TBSₜₑₘₚ=N_{RE}*R*Qₘ*u, where R is the target coding rate, Qₘ is the modulation order and ν is the number of MIMO layers.

N_{info} is then used for calculating a quantized intermediate variable

$${N}_{info}^{′} ,$$

which is then used to find the closest valid TBS.

It should be noted that in case the new type of TBoMS transmission is scheduled with repetition, TBS calculation is based on the resource allocated for the first repetition.

Hereinafter, the time domain resource and the frequency domain resource determination in case the new type of TBoMS transmission is scheduled with repetitions will be described with referent to FIG. 5A and FIG. 5B.

In one embodiment, as illustrated in FIG. 5A, the exact allocation of the portion of TBoMS on SBFD slots and the exact allocation of the portion of TBoMS on Non-SBFD slots are applied across the repetitions throughout the TDD pattern. In the example of repetition of the proposed TBoMS for SBFD operation as illustrated in FIG. 5A, the same resource allocation of a single TBoMS per TDD pattern is repeated. In the TDD pattern, the repetition may include the repetitions for the starting slot, the number of slots, and the number of PRBs on the repeated pattern of SBFD and Non-SBFD slots, respectively.

As illustrated in FIG. 5A, for each of the first, second, third and fourth repetitions, the slot for TBoMS repetition is started at the second slot of SBFD slots, and the number of slots allocated for TBoMS repetition is three, and the number of PRBs keeps unchanged.

Although illustrations in FIG. 3A to 3C and FIG. 5A show that a single TBoMS spans across back-to-back slots, the proposed solution also works for the case when a single TBoMS spans across non back-to-back slots (e.g., as shown in FIG. 5B for 3rd repetition and 4th repletion which will be described hereinafter.

In one embodiment as illustrated in FIG. 5B, UE firstly determines the repetition of the resource in time domain on the available UL slots based on Nₛₗₒₜ (e.g., every 3 available slots as illustrated in FIG. 5B for Nₛₗₒₜ=3). Then, for each repetition, UE applies the determined

$${N}_{P R B}^{SBFD} and {N}_{P R B}^{non - SBFD}$$

for determining the resource in frequency domain for the portion of the resource of the repetition in SBFD and Non-SBFD slots, respectively. In the example of repetition of the proposed TBoMS for SBFD operation as illustrated in FIG. 5B, repetition is firstly applied on the available UL slots in time domain and the resource in frequency domain in each slot for each repetition is then determined based on the slot type.

As illustrated in FIG. 5B, the first repetition is firstly applied on the available three UL slots in time domain, including two SBFD slots and one Non-SBFD slot, and the resource

$${N}_{P R B}^{SBFD} or {N}_{P R B}^{non - SBFD}$$

in frequency domain in each slot for the first repetition is determined based on the slot type of SBFD or Non-SBFD. The second repetition is then applied on the other three available UL slots in time domain, including three SBFD slots, and the resource

$${N}_{P R B}^{S B F D}$$

in frequency domain in each slot for the second repetition corresponds to the frequency resource for the SBFD slot. The third repetition is then applied on the other three available UL slots in time domain, which are not consecutive. The fourth repetition is then applied on the other three available UL slots in time domain, which are also not consecutive.

Referring back to FIG. 4, at step 5, the UE 120 transmits and the NW 110 receives the encoded bits the transport block with the determined transport block size via the determined time and frequency domain resources.

In the present disclosure, it proposes a new type of single TBoMS transmission for SBFD operation, and this type of single TBoMS is transmitted on the resource that spans across SBFD slots and Non-SBFD slots, and the number of PRBs allocated for the portion of resource in SBFD slots

$$( {N}_{P R B}^{S B F D} )$$

is preferably different from (smaller than) number of PRBs allocated for the portion of resource in Non-SBFD slots

$$( {N}_{P R B}^{non - SBFD} ) .$$

By determining resource blocks for different portions of the uplink transmission, the legacy TBoMS operation may be improved so as to well exploit different characteristics of SBFD and Non-SBFD slots in case a single TBoMS spans across the two slot types. For example, it may improve the performance in interference slot, such as in SBFD slots due to a small number of PRBs allocated for it, and at the same time, it may reduce latency or increase TBS and thus improve throughput for the Non-SBFD slots.

FIG. 6 illustrates a flowchart of an example method 600 implemented at a terminal device in accordance with some other embodiments of the present disclosure. For the purpose of discussion, the method 600 will be described from the perspective of the terminal device 120 with reference to FIG. 1A.

At block 610, the terminal device 120 receives, from a network device, scheduling information scheduling an uplink transmission across a first set of slots with a first slot type and a second set of slots with a second slot type. At block 620, the terminal device 120 determines, based at least partially on the scheduling information, a first number of resource blocks (RBs) per slot for a first portion of the uplink transmission across the first set of slots and a second number of RBs per slot for a second portion of the uplink transmission across the second set of slots. At block 630, the terminal device 120 transmits the uplink transmission to the network device.

In some embodiments, the scheduling information comprises a total number of slots allocated for the uplink transmission, and a start slot for the uplink transmission. In some embodiments, the terminal device is further caused to: prior to determining the first number of RBs and the second number of RBs, determine the first set of slots and the second set of slots, based on the start slot for the uplink transmission and the total number of slots.

In some embodiments, the uplink transmission comprises a transport block processing over multiple slots (TBoMS) without repetitions.

In some embodiments, the uplink transmission comprises a transport block processing over multiple slots (TBoMS) with repetitions.

In some embodiments, the first slot type is a type of sub-band full duplex (SBFD) slots or flexible slots, in which at least one frequency sub-band is used for reception via downlink channels, and at least one frequency sub-band is used for transmission via uplink channels; the second slot type is a type of Non-SBFD slots or static slots, in which the entire frequency band is used for reception via downlink channels or transmission via uplink channels; and the first number is equal to or less than the second number.

In some embodiments, the scheduling information further comprises a number of RBs per slot indicated by the network device, and in the event that a start slot for the uplink transmission is of the first slot type, the first number is the number of RBs per slot indicated by the scheduling information, and the second number equals to the first number scaled by a factor; or in the event that the start slot for the uplink transmission is of the second slot type, the second number is the number of RBs per slot indicated by the scheduling information, and the first number equals to the second number scaled by the factor.

In some embodiments, the factor is determined by the terminal device or indicated by the network device.

In some embodiments, the factor is determined by the terminal device based on a number of slots in the first set of slots and a number of slots in the second set of slots.

In some embodiments, the factor is determined by the terminal device further based on a value configured by the network device.

In some embodiments, the value is configured by the network device for at least one of the following: a row of a time domain resource assignment (TDRA) table, or a size of uplink frequency sub-band in slots with the first slot type.

In some embodiments, the scheduling information further comprises: a third number of resource blocks (RBs), which is size of the frequency sub-band for transmissions via uplink channels in slots with the first slot type; and a fourth number of RBs, which is size of the frequency band for transmissions via uplink channels in slots with the second slot type, and the factor is determined based on the third number and the fourth number.

In some embodiments, the factor is configured by the network device for at least one of the following: a row of a time domain resource assignment (TDRA) table, or a size of uplink frequency sub-band in slots with the first slot type.

In some embodiments, the scheduling information further comprises: an offset and a start RB for the uplink transmission, wherein the offset is indicative of at least one of the following: a first difference between a start RB of the first number of RBs and a start RB of the second number of RBs; a second difference between a start RB of the frequency sub-band for transmissions via uplink channels in slots with the first slot type and the start RB of the first number of RBs; a third difference between a start RB of the frequency band for transmissions via uplink channels in slots with the first slot type and the start RB of the second number of RBs; a fourth difference between a start RB of the frequency band for transmissions via uplink channels in slots with the second slot type and the start RB of the first number of RBs; or a fifth between a start RB of the frequency band for transmissions via uplink channels in slots with the second slot type and the start RB of the second number of RBs.

In some embodiments, the terminal device is further caused to: determine, based on the offset and the start RB for the uplink transmission, the start RB of the first number of RBs from at least one of the following: the start RB of the second number of RBs; the start RB of the frequency sub-band for transmissions via uplink channels in slots with the first slot type; or the start RB of the frequency band for transmissions via uplink channels in slots with the second slot type.

In some embodiments, the terminal device is further caused to: determine, based on the offset and the start RB for the uplink transmission, the start RB of the second number of RBs from at least one of the following: the start RB of the first number of RBs; the start RB of the frequency sub-band for transmissions via uplink channels in slots with the first slot type; or the start RB of the frequency band for transmissions via uplink channels in slots with the second slot type.

In some embodiments, in the event that a start slot for the uplink transmission is of the first slot type, the start RB of the first number of RBs is the start RB for the uplink transmission and the start RB of the second number of RBs is determined based on the first difference, or based on the second difference and the third difference, or based on the fourth difference and the fifth difference; or in the event that the start slot for the uplink transmission is of the second slot type, the start RB of the second number of RBs is the start RB for the uplink transmission and the start RB of the first number of RBs is determined based on the first difference, or based on the second difference and the third difference, or based on the fourth difference and the fifth difference.

In some embodiments, the terminal device is further caused to: determine, a transport block size (TBS) for the uplink transmission, based on a product of the first number and the number of slots in the first set of slots and a product of the second number and the number of slots in the second set of slots.

In some embodiments, the terminal device is further caused to determine, the transport block size (TBS) for the uplink transmission, further based on an intermediate variable calculated based on the product of the first number and the number of slots in the first set of slots and the product of the second number and the number of slots in the second set of slots.

In some embodiments, the uplink transmission comprises a transport block processing over multiple slots (TBoMS) with a plurality of repetitions, and a resource allocated for a first repetition of the plurality of repetitions is repeated at a second repetition of the plurality of repetitions in Time division duplexing (TDD) pattern.

In some embodiments, the uplink transmission comprises a transport block processing over multiple slots (TBoMS) with a plurality of repetitions, a resource in time domain for the repetition is determined by the terminal device based on a total number of slots allocated for the TBoMS on available uplink slots, and the first number of RBs in frequency domain are determined for a portion of the repetition across the slots with the first slot type, and the second number of RBs in frequency domain are determined for a portion of the repetition across the slots with the second slot type.

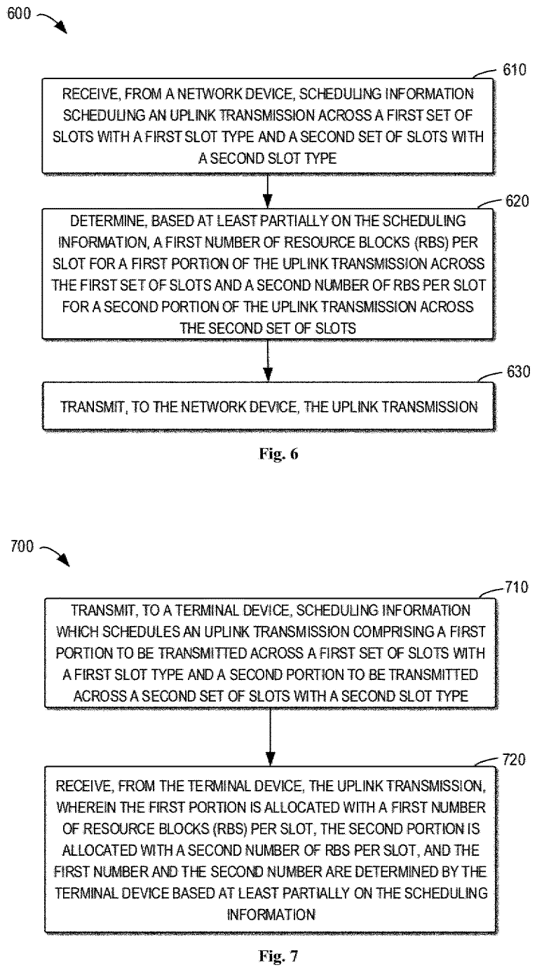

FIG. 7 illustrates a flowchart of an example method 700 implemented at a network device in accordance with some other embodiments of the present disclosure. For the purpose of discussion, the method 700 will be described from the perspective of the network device 110 with reference to FIG. 1A.

At block 710, the network device 110 transmits, to a terminal device, scheduling information which schedules an uplink transmission comprising a first portion to be transmitted across a first set of slots with a first slot type and a second portion to be transmitted across a second set of slots with a second slot type. At block 720, the network device 110 receives, from the terminal device, the uplink transmission, the first portion is allocated with a first number of resource blocks (RBs) per slot, the second portion is allocated with a second number of RBs per slot, and the first number and the second number are determined by the terminal device based at least partially on the scheduling information.

In some embodiments, the scheduling information comprises a total number of slots allocated for the uplink transmission, and a start slot for the uplink transmission, and the total number is equal to a sum of a number of the first set of slots and a number of the second set of slots which are determined by the terminal device based on the start slot for the uplink transmission and the total number of slots, respectively.

In some embodiments, the uplink transmission comprises a transport block processing over multiple slots (TBoMS) without repetitions.

In some embodiments, the uplink transmission comprises a transport block processing over multiple slots (TBoMS) with at least one repetition.

In some embodiments, the first slot type is a type of sub-band full duplex (SBFD) slots or flexible slots, in which at least one frequency sub-band is used for reception via downlink channels, and at least one frequency sub-band is used for transmission via uplink channels; the second slot type is a type of Non-SBFD slots or static slots, in which the entire frequency band is used for reception via downlink channels or transmission via uplink channels; and the first number is equal to or less than the second number.

In some embodiments, the scheduling information further comprises a number of RBs per slot indicated by the network device, and wherein in the event that a start slot for the uplink transmission is of the first slot type, the first number is the number of RBs per slot indicated by the scheduling information, and the second number equals to the first number scaled by a factor; or in the event that the start slot for the uplink transmission is of the second slot type, the second number is the number of RBs per slot indicated by the scheduling information, and the first number equals to the second number scaled by the factor.

In some embodiments, the factor is determined by the terminal device or indicated by the network device.

In some embodiments, the factor is determined by the terminal device based on a number of slots in the first set of slots and a number of slots in the second set of slots.

In some embodiments, the factor is determined by the terminal device further based on a value configured by the network device.

In some embodiments, the value is configured by the network device for at least one of the following: a row of a time domain resource assignment (TDRA) table, and a size of uplink frequency sub-band in slots with the first slot type.

In some embodiments, the scheduling information further comprises: a third number of resource blocks (RBs), which is size of the frequency sub-band for transmissions via uplink channels in slots with the first slot type, and a fourth number of RBs, which is size of the frequency band for transmissions via uplink channels in slots with the second slot type, the factor is determined based on the third number and the fourth number.

In some embodiments, the factor is configured by the network device for at least one of the following: a row of a time domain resource assignment (TDRA) table, or a size of uplink frequency sub-band in slots with the first slot type.

In some embodiments, the scheduling information further comprises: an offset and a start RB for the uplink transmission, wherein the offset is indicative of at least one of the following: a first difference between a start RB of the first number of RBs and a start RB of the second number of RBs; a second difference between a start RB of the frequency sub-band for transmissions via uplink channels in slots with the first slot type and the start RB of the first number of RBs; a third difference between a start RB of the frequency band for transmissions via uplink channels in slots with the first slot type and the start RB of the second number of RBs; a fourth difference between a start RB of the frequency band for transmissions via uplink channels in slots with the second slot type and the start RB of the first number of RBs; or a fifth between a start RB of the frequency band for transmissions via uplink channels in slots with the second slot type and the start RB of the second number of RBs.

In some embodiments, based on the offset and the start RB for the uplink transmission, the start RB of the first number of RBs is determined by the terminal device from at least one of the following: the start RB of the second number of RBs; the start RB of the frequency sub-band for transmissions via uplink channels in slots with the first slot type; or the start RB of the frequency band for transmissions via uplink channels in slots with the second slot type, or based on the offset and the start RB for the uplink transmission, the start RB of the second number of RBs is determined by the terminal device from at least one of the following: the start RB of the first number of RBs; the start RB of the frequency sub-band for transmissions via uplink channels in slots with the first slot type; or the start RB of the frequency band for transmissions via uplink channels in slots with the second slot type.

In some embodiments, in the event that a start slot for the uplink transmission is of the first slot type, the start RB of the first number of RBs is the start RB for the uplink transmission and the start RB of the second number of RBs is determined based on the first difference, or based on the second difference and the third difference, or based on the fourth difference and the fifth difference; or in the event that the start slot for the uplink transmission is of the second slot type, the start RB of the second number of RBs is the start RB for the uplink transmission and the start RB of the first number of RBs is determined based on the first difference, or based on the second difference and the third difference, or based on the fourth difference and the fifth difference.

In some embodiments, a transport block size (TBS) for the uplink transmission is determined by the terminal device based on a product of the first number and the number of slots in the first set of slots and a product of the second number and the number of slots in the second set of slots.

In some embodiments, the transport block size (TBS) for the uplink transmission is further based on an intermediate variable calculated based on the product of the first number and the number of the first set of slots and the product of the second number and the number of the second set of slots.

In some embodiments, the uplink transmission comprises a transport block processing over multiple slots (TBoMS) with a plurality of repetitions, a resource in time domain for the repetition is determined by the terminal device based on a total number of slots allocated for the TBoMS on available uplink slots, and the first number of RBs in frequency domain are determined for a portion of the repetition across the slots with the first slot type, and the second number of RBs in frequency domain are determined for a portion of the repetition across the slots with the second slot type.

In some embodiments, an apparatus (for example, the terminal device 120) capable of performing the method 600 may comprise means for performing the respective steps of the method 600. The means may be implemented in any suitable form. For example, the means may be implemented in a circuitry or software module.

In some embodiments, the apparatus comprises: means for receiving, from a network device, scheduling information scheduling an uplink transmission across a first set of slots with a first slot type and a second set of slots with a second slot type; means for determining, based at least partially on the scheduling information, a first number of resource blocks (RBs) per slot for a first portion of the uplink transmission across the first set of slots and a second number of RBs per slot for a second portion of the uplink transmission across the second set of slots; and means for transmitting, to the network device, the uplink transmission.

In some embodiments, the scheduling information comprises a total number of slots allocated for the uplink transmission, and a start slot for the uplink transmission.

In some embodiments, the terminal device further comprises means for determining the first set of slots and the second set of slots, based on the start slot for the uplink transmission and the total number of slots, prior to determining the first number of RBs and the second number of RBs.

In some embodiments, the uplink transmission comprises a transport block processing over multiple slots (TBoMS) without repetitions.

In some embodiments, the uplink transmission comprises a transport block processing over multiple slots (TBoMS) with repetitions.

In some embodiments, the first slot type is a type of sub-band full duplex (SBFD) slots or flexible slots, in which at least one frequency sub-band is used for reception via downlink channels, and at least one frequency sub-band is used for transmission via uplink channels; the second slot type is a type of Non-SBFD slots or static slots, in which the entire frequency band is used for reception via downlink channels or transmission via uplink channels; and the first number is equal to or less than the second number.

In some embodiments, the scheduling information further comprises a number of RBs per slot indicated by the network device, and in the event that a start slot for the uplink transmission is of the first slot type, the first number is the number of RBs per slot indicated by the scheduling information, and the second number equals to the first number scaled by a factor; or in the event that the start slot for the uplink transmission is of the second slot type, the second number is the number of RBs per slot indicated by the scheduling information, and the first number equals to the second number scaled by the factor.

In some embodiments, the factor is determined by the terminal device or indicated by the network device.

In some embodiments, the factor is determined by the terminal device based on a number of slots in the first set of slots and a number of slots in the second set of slots.

In some embodiments, the factor is determined by the terminal device further based on a value configured by the network device.

In some embodiments, the value is configured by the network device for at least one of the following: a row of a time domain resource assignment (TDRA) table, or a size of uplink frequency sub-band in slots with the first slot type.

In some embodiments, the scheduling information further comprises: a third number of resource blocks (RBs), which is size of the frequency sub-band for transmissions via uplink channels in slots with the first slot type; and a fourth number of RBs, which is size of the frequency band for transmissions via uplink channels in slots with the second slot type, and the factor is determined based on the third number and the fourth number.

In some embodiments, the factor is configured by the network device for at least one of the following: a row of a time domain resource assignment (TDRA) table, or a size of uplink frequency sub-band in slots with the first slot type.

In some embodiments, the scheduling information further comprises: an offset and a start RB for the uplink transmission, the offset is indicative of at least one of the following: a first difference between a start RB of the first number of RBs and a start RB of the second number of RBs; a second difference between a start RB of the frequency sub-band for transmissions via uplink channels in slots with the first slot type and the start RB of the first the second number of RBs; a third difference between a start RB of the frequency band for transmissions via uplink channels in slots with the first slot type and the start RB of the second number of RBs; a fourth difference between a start RB of the frequency band for transmissions via uplink channels in slots with the second slot type and the start RB of the first number of RBs; or a fifth between a start RB of the frequency band for transmissions via uplink channels in slots with the second slot type and the start RB of the second number of RBs.

In some embodiments, the terminal device further comprises means for determining, based on the offset and the start RB for the uplink transmission, the start RB of the first number of RBs from at least one of the following: the start RB of the second number of RBs; the start RB of the frequency sub-band for transmissions via uplink channels in slots with the first slot type; or the start RB of the frequency band for transmissions via uplink channels in slots with the second slot type, or means for determining, based on the offset and the start RB for the uplink transmission, the start RB of the second number of RBs from at least one of the following: the start RB of the first number of RBs; the start RB of the frequency sub-band for transmissions via uplink channels in slots with the first slot type; or the start RB of the frequency band for transmissions via uplink channels in slots with the second slot type.

In some embodiments, in the event that a start slot for the uplink transmission is of the first slot type, the start RB of the first number of RBs is the start RB for the uplink transmission and the start RB of the second number of RBs is determined based on the first difference, or based on the second difference and the third difference, or based on the fourth difference and the fifth difference; or in the event that the start slot for the uplink transmission is of the second slot type, the start RB of the second number of RBs is the start RB for the uplink transmission and the start RB of the first number of RBs is determined based on the first difference, or based on the second difference and the third difference, or based on the fourth difference and the fifth difference.

In some embodiments, the terminal device further comprises means for determining, a transport block size (TBS) for the uplink transmission, based on a product of the first number and the number of slots in the first set of slots and a product of the second number and the number of slots in the second set of slots.

In some embodiments, the terminal device further comprises means for determining, the transport block size (TBS) for the uplink transmission, further based on an intermediate variable calculated based on the product of the first number and the number of slots in the first set of slots and the product of the second number and the number of slots in the second set of slots.

In some embodiments, the uplink transmission comprises a transport block processing over multiple slots (TBoMS) with a plurality of repetitions, and a resource allocated for a first repetition of the plurality of repetitions is repeated at a second repetition of the plurality of repetitions in Time division duplexing (TDD) pattern.

In some embodiments, the uplink transmission comprises a transport block processing over multiple slots (TBoMS) with a plurality of repetitions, a resource in time domain for the repetition is determined by the terminal device based on a total number of slots allocated for the TBoMS on available uplink slots, and the first number of RBs in frequency domain are determined for a portion of the repetition across the slots with the first slot type, and the second number of RBs in frequency domain are determined for a portion of the repetition across the slots with the second slot type.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, an apparatus (for example, the network device 110) capable of performing the method 700 may comprise means for performing the respective steps of the method 700. The means may be implemented in any suitable form. For example, the means may be implemented in a circuitry or software module.

In some embodiments, the apparatus comprises: means for transmitting, to a terminal device, scheduling information which schedules an uplink transmission comprising a first portion to be transmitted across a first set of slots with a first slot type and a second portion to be transmitted across a second set of slots with a second slot type; and means for receiving, from the terminal device, the uplink transmission, wherein the first portion is allocated with a first number of resource blocks (RBs) per slot, the second portion is allocated with a second number of RBs per slot, and the first number and the second number are determined by the terminal device based at least partially on the scheduling information.

In some embodiments, the scheduling information comprises a total number of slots allocated for the uplink transmission, and a start slot for the uplink transmission, and the total number is equal to a sum of a number of the first set of slots and a number of the second set of slots which are determined by the terminal device based on the start slot for the uplink transmission and the total number of slots, respectively.

In some embodiments, the uplink transmission comprises a transport block processing over multiple slots (TBoMS) without repetitions.

In some embodiments, the uplink transmission comprises a transport block processing over multiple slots (TBoMS) with at least one repetition.

In some embodiments, the first slot type is a type of sub-band full duplex (SBFD) slots or flexible slots, in which at least one frequency sub-band is used for reception via downlink channels, and at least one frequency sub-band is used for transmission via uplink channels; the second slot type is a type of Non-SBFD slots or static slots, in which the entire frequency band is used for reception via downlink channels or transmission via uplink channels; and the first number is equal to or less than the second number.

In some embodiments, the scheduling information further comprises a number of RBs per slot indicated by the network device, and in the event that a start slot for the uplink transmission is of the first slot type, the first number is the number of RBs per slot indicated by the scheduling information, and the second number equals to the first number scaled by a factor; or in the event that the start slot for the uplink transmission is of the second slot type, the second number is the number of RBs per slot indicated by the scheduling information, and the first number equals to the second number scaled by the factor.

In some embodiments, the factor is determined by the terminal device or indicated by the network device.

In some embodiments, the factor is determined by the terminal device based on a number of slots in the first set of slots and a number of slots in the second set of slots.

In some embodiments, the factor is determined by the terminal device further based on a value configured by the network device.

In some embodiments, the value is configured by the network device for at least one of the following: a row of a time domain resource assignment (TDRA) table, and a size of uplink frequency sub-band in slots with the first slot type.

In some embodiments, the scheduling information further comprises: a third number of resource blocks (RBs), which is size of the frequency sub-band for transmissions via uplink channels in slots with the first slot type, and a fourth number of RBs, which is size of the frequency band for transmissions via uplink channels in slots with the second slot type, wherein the factor is determined based on the third number and the fourth number.

In some embodiments, the factor is configured by the network device for at least one of the following: a row of a time domain resource assignment (TDRA) table, or a size of uplink frequency sub-band in slots with the first slot type.

In some embodiments, the scheduling information further comprises: an offset and a start RB for the uplink transmission, the offset is indicative of at least one of the following: a first difference between a start RB of the first number of RBs and a start RB of the second number of RBs; a second difference between a start RB of the frequency sub-band for transmissions via uplink channels in slots with the first slot type and the start RB of the first number of RBs; a third difference between a start RB of the frequency band for transmissions via uplink channels in slots with the first slot type and the start RB of the second number of RBs; a fourth difference between a start RB of the frequency band for transmissions via uplink channels in slots with the second slot type and the start RB of the first number of RBs; or a fifth between a start RB of the frequency band for transmissions via uplink channels in slots with the second slot type and the start RB of the second number of RBs.

In some embodiments, based on the offset and the start RB for the uplink transmission, the start RB of the first number of RBs is determined by the terminal device from at least one of the following: the start RB of the second number of RBs; the start RB of the frequency sub-band for transmissions via uplink channels in slots with the first slot type; or the start RB of the frequency band for transmissions via uplink channels in slots with the second slot type, or based on the offset and the start RB for the uplink transmission, the start RB of the second number of RBs is determined by the terminal device from at least one of the following: the start RB of the first number of RBs; the start RB of the frequency sub-band for transmissions via uplink channels in slots with the first slot type; or the start RB of the frequency band for transmissions via uplink channels in slots with the second slot type.

In some embodiments, in the event that a start slot for the uplink transmission is of the first slot type, the start RB of the first number of RBs is the start RB for the uplink transmission and the start RB of the second number of RBs is determined based on the first difference, or based on the second difference and the third difference, or based on the fourth difference and the fifth difference; or in the event that the start slot for the uplink transmission is of the second slot type, the start RB of the second number of RBs is the start RB for the uplink transmission and the start RB of the first number of RBs is determined based on the first difference, or based on the second difference and the third difference, or based on the fourth difference and the fifth difference.

In some embodiments, a transport block size (TBS) for the uplink transmission is determined by the terminal device based on a product of the first number and the number of slots in the first set of slots and a product of the second number and the number of slots in the second set of slots.

In some embodiments, the transport block size (TBS) for the uplink transmission is further based on an intermediate variable calculated based on the product of the first number and the number of the first set of slots and the product of the second number and the number of the second set of slots.

In some embodiments, the uplink transmission comprises a transport block processing over multiple slots (TBoMS) with a plurality of repetitions, and a resource allocated for a first repetition of the plurality of repetitions is repeated at a second repetition of the plurality of repetitions in Time division duplexing (TDD) pattern.

In some embodiments, the uplink transmission comprises a transport block processing over multiple slots (TBoMS) with a plurality of repetitions, a resource in time domain for the repetition is determined by the terminal device based on a total number of slots allocated for the TBoMS on available uplink slots, and the first number of RBs in frequency domain are determined for a portion of the repetition across the slots with the first slot type, and the second number of RBs in frequency domain are determined for a portion of the repetition across the slots with the second slot type.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

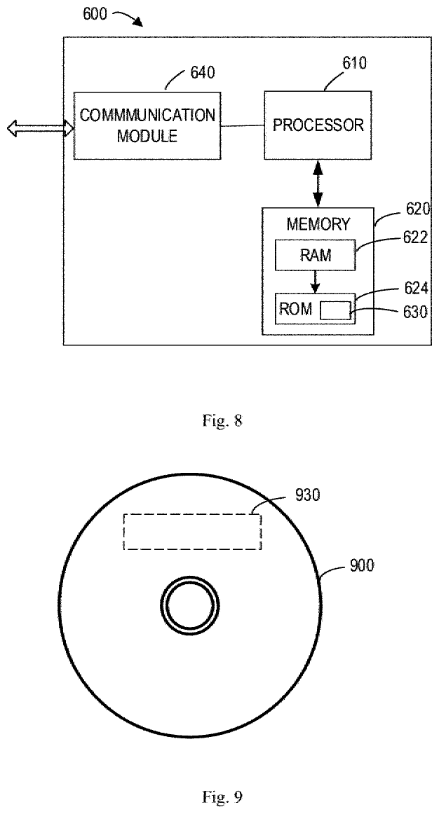

FIG. 8 is a simplified block diagram of a device 800 that is suitable for implementing embodiments of the present disclosure. The device 800 may be provided to implement the communication device, for example the terminal device 120 and the network device 11 as shown in FIG. 1A. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network devices.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a read only memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that may not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program so that the device 800 may perform any process of the disclosure as discussed with reference to FIG. 6 and FIG. 7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like.

FIG. 9 illustrates an example of the computer readable medium 900 in form of CD or DVD in accordance with some embodiments of the present disclosure. The computer readable medium has the program 930 stored thereon. It is noted that although the computer-readable medium 900 is depicted in form of CD or DVD, the computer-readable medium 900 may be in any other form suitable for carry or hold the program 830.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIG. 6 to FIG. 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that may be described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above may be disclosed as example forms of implementing the claims.

### LIST OF ABBREVIATIONS

CLI Cross link interference
DCI Downlink control information
DL Downlink
EPRE Energy per resource element
FDD Frequency division duplexing
FDU Flexible division duplexing
NW Network
PUSCH Physical uplink shared channel
PRB Physical resource block
RRC Radio resource control
SBFD Subband full duplex
SLIV Start and length indicator value
TBoMS Transport block processing over multiple slots
TBS Transport block size
TDD Time division duplexing
TDRA Time domain resource assignment
UCI Uplink control information
UE User equipment
UL Uplink
URLLC Ultra-reliable low latency
xDD Cross division duplexing

1. A terminal device comprising:
at least one processor; and
at least one memory storing instructions that, when executed by the at least one processor, cause the terminal device at least to:
receive, from a network device, scheduling information scheduling an uplink transmission across a first set of slots with a first slot type and a second set of slots with a second slot type;
determine, based at least partially on the scheduling information, a first number of resource blocks (RBs) per slot for a first portion of the uplink transmission across the first set of slots and a second number of RBs per slot for a second portion of the uplink transmission across the second set of slots; and
transmit, to the network device, the uplink transmission.

2. The terminal device of claim 1, wherein the scheduling information comprises a total number of slots allocated for the uplink transmission, and a start slot for the uplink transmission.

3. The terminal device of claim 2, wherein the terminal device is further caused to:
prior to determining the first number of RBs and the second number of RBs, determine the first set of slots and the second set of slots, based on the start slot for the uplink transmission and the total number of slots.

4. The terminal device of claim 1, wherein the uplink transmission comprises a transport block processing over multiple slots (TBoMS) without repetitions.

5. The terminal device of claim 1, wherein the uplink transmission comprises a transport block processing over multiple slots (TBoMS) with repetitions.

6. The terminal device of claim 1, wherein:
the first slot type is a type of sub-band full duplex (SBFD) slots or flexible slots, in which at least one frequency sub-band is used for reception via downlink channels, and at least one frequency sub-band is used for transmission via uplink channels;
the second slot type is a type of Non-SBFD slots or static slots, in which the entire frequency band is used for reception via downlink channels or transmission via uplink channels; and
the first number is equal to or less than the second number.

7. The terminal device of claim 1, wherein the scheduling information further comprises a number of RBs per slot indicated by the network device, and wherein:
in the event that a start slot for the uplink transmission is of the first slot type, the first number is the number of RBs per slot indicated by the scheduling information, and the second number equals to the first number scaled by a factor; or
in the event that the start slot for the uplink transmission is of the second slot type, the second number is the number of RBs per slot indicated by the scheduling information, and the first number equals to the second number scaled by the factor, and
wherein the factor is determined by the terminal device or indicated by the network device.

8. (canceled)

9. The terminal device of claim 7, wherein the factor is determined by the terminal device based on a number of slots in the first set of slots and a number of slots in the second set of slots.

10. The terminal device of claim 9, wherein the factor is determined by the terminal device further based on a value configured by the network device.

11. The terminal device of claim 10, wherein the value is configured by the network device for at least one of the following:
a row of a time domain resource assignment (TDRA) table, or
a size of uplink frequency sub-band in slots with the first slot type.

12. The terminal device of claim 7, wherein the scheduling information further comprises:
a third number of resource blocks (RBs), which is size of the frequency sub-band for transmissions via uplink channels in slots with the first slot type; and
a fourth number of RBs, which is size of the frequency band for transmissions via uplink channels in slots with the second slot type,
wherein the factor is determined based on the third number and the fourth number.

13. The terminal device of claim 7, wherein the factor is configured by the network device for at least one of the following:
a row of a time domain resource assignment (TDRA) table, or
a size of uplink frequency sub-band in slots with the first slot type.

14. The terminal device of claim 1, wherein the scheduling information further comprises:
an offset indicative of at least one of the following:
a first difference between a start RB of the first number of RBs and a start RB of the second number of RBs;
a second difference between a start RB of the frequency sub-band for transmissions via uplink channels in slots with the first slot type and the start RB of the first the second number of RBs;
a third difference between a start RB of the frequency band for transmissions via uplink channels in slots with the first slot type and the start RB of the second number of RBs;
a fourth difference between a start RB of the frequency band for transmissions via uplink channels in slots with the second slot type and the start RB of the first number of RBs; or
a fifth between a start RB of the frequency band for transmissions via uplink channels in slots with the second slot type and the start RB of the second number of RBs; and
a start RB for the uplink transmission.

15. The terminal device of claim 14, wherein the terminal device is further caused to:
determine, based on the offset and the start RB for the uplink transmission, the start RB of the first number of RBs from at least one of the following:
the start RB of the second number of RBs;
the start RB of the frequency sub-band for transmissions via uplink channels in slots with the first slot type; or
the start RB of the frequency band for transmissions via uplink channels in slots with the second slot type, or
determine, based on the offset and the start RB for the uplink transmission, the start RB of the second number of RBs from at least one of the following:
the start RB of the first number of RBs;
the start RB of the frequency sub-band for transmissions via uplink channels in slots with the first slot type; or
the start RB of the frequency band for transmissions via uplink channels in slots with the second slot type.

16. The terminal device of claim 14, wherein:
in the event that a start slot for the uplink transmission is of the first slot type, the start RB of the first number of RBs is the start RB for the uplink transmission and the start RB of the second number of RBs is determined based on the first difference, or based on the second difference and the third difference, or based on the fourth difference and the fifth difference; or
in the event that the start slot for the uplink transmission is of the second slot type, the start RB of the second number of RBs is the start RB for the uplink transmission and the start RB of the first number of RBs is determined based on the first difference, or based on the second difference and the third difference, or based on the fourth difference and the fifth difference.

17. The terminal device of claim 1, wherein the terminal device is further caused to: determine, a transport block size (TBS) for the uplink transmission, based on at least one of:
a product of the first number and the number of slots in the first set of slots and a product of the second number and the number of slots in the second set of slots, or
an intermediate variable calculated based on the product of the first number and the number of slots in the first set of slots and the product of the second number and the number of slots in the second set of slots.

18. (canceled)

19. The terminal device of claim 1, wherein the uplink transmission comprises a transport block processing over multiple slots (TBoMS) with a plurality of repetitions, and
wherein a resource allocated for a first repetition of the plurality of repetitions is repeated at a second repetition of the plurality of repetitions in Time division duplexing (TDD) pattern.

20. The terminal device of claim 1, wherein the uplink transmission comprises a transport block processing over multiple slots (TBoMS) with a plurality of repetitions,
a resource in time domain for the repetition is determined by the terminal device based on a total number of slots allocated for the TBoMS on available uplink slots, and
the first number of RBs in frequency domain are determined for a portion of the repetition across the slots with the first slot type, and the second number of RBs in frequency domain are determined for a portion of the repetition across the slots with the second slot type.

21. A network device, comprising:
at least one processor; and
at least one memory storing instructions that, when executed by the at least one processor, cause the network device at least to:
transmit, to a terminal device, scheduling information which schedules an uplink transmission comprising a first portion to be transmitted across a first set of slots with a first slot type and a second portion to be transmitted across a second set of slots with a second slot type; and
receive, from the terminal device, the uplink transmission, wherein the first portion is allocated with a first number of resource blocks (RBs) per slot, the second portion is allocated with a second number of RBs per slot, and the first number and the second number are determined by the terminal device based at least partially on the scheduling information.

22.-39. (canceled)

40. A method performed at a terminal device, comprising:
receiving, from a network device, scheduling information scheduling an uplink transmission across a first set of slots with a first slot type and a second set of slots with a second slot type;
determining, based at least partially on the scheduling information, a first number of resource blocks (RBs) per slot for a first portion of the uplink transmission across the first set of slots and a second number of RBs per slot for a second portion of the uplink transmission across the second set of slots; and
transmitting, to the network device, the uplink transmission.

41.-44. (canceled)
